(19) United States
(12) Patent Application Publication
(10) Pub. No.: US 2018/0281505 A1
(43) Pub. Date: Oct. 4, 2018

(54) PENCIL SHARPENER HAVING A GUIDE ELEMENT FOR DISCHARGING SHAVINGS

(71) Applicant: Fritz Lüttgens, Erlangen (DE)

(72) Inventor: Fritz Lüttgens, Erlangen (DE)

(21) Appl. No.: 15/934,654

(22) Filed: Mar. 23, 2018

(30) Foreign Application Priority Data
Mar. 31, 2017 (DE) 102017107006.0

(51) Int. Cl. B43L 23/08

(52) U.S. Cl. CPC B43L 23/08

(57) ABSTRACT

A pencil sharpener (1) having a sharpener body (2), having at least one guide cone (7) situated in the sharpener body (2) for guiding the pencil tip (5) during sharpening, and having a cutting blade (3) fixed to the sharpener body (2), tangentially with respect to the guide cone (7), for shaving the pencil tip (5) in such a way that the pencil tip (5) at the front end has a tapered pencil lead section (24) without casing material, and an adjoining casing section (26) in the center longitudinal direction (20) of the pencil (4) with a pencil lead casing (23) made of casing material, in which the pencil lead (25) of the pencil (4) is embedded, with a guide element (16), which is situated in the area of the main cutting edge (12) of the cutting blade (3) and which engages with the pencil tip (5) in the area of the separating line (27) in the transition area between the pencil lead section (24) and the casing section (26), and which acts on the pencil tip (5), without cutting, in such a way that the shavings of the pencil lead material in the pencil lead section (24) and the shavings of the casing material in the casing section (26) are discharged separately.

The invention relates to a pencil sharpener.

The starting point for the invention is a pencil sharpener according to the preamble of Claim 1. According to the prior art, these types of pencil sharpeners have a sharpener body and at least one guide cone situated in the sharpener body. The guide cone is used for guiding the tip of the pencil to be sharpened during the sharpening operation. In addition, a cutting blade, oriented tangentially with respect to the guide cone, for shaving the pencil tip at the sharpener body is fixed to the pencil sharpener in the area of the guide cone.

All pencils, in particular wood-encased or plastic-encased pencils, may be sharpened with sharpeners of this type. The pencils have a pencil lead and a pencil lead casing in which the pencil lead is embedded. The pencil lead is thus initially completely enclosed by the pencil lead casing.

Due to the guide cone, designed as a hollow cone, on the sharpener body, and the cutting blade situated tangentially with respect to the guide cone on the sharpener body, a conically tapered pencil tip results during shaving of a pencil end. The pencil tip has a pencil lead section that is completely exposed from the casing material of the pencil lead casing, and an adjoining casing section in the center longitudinal direction of the pencil. In the area of the casing section, the pencil lead is also fixedly surrounded on all sides in the pencil lead casing. However, the casing material in the area of the casing section is also partially shaved in such a way that the casing section is likewise conically tapered and ideally seamlessly merges into the pencil lead section.

Since the pencil lead and the pencil lead casing are made of different materials due to their completely different technical functions, completely different shavings also result during cutting of the pencil tip.

A container sharpener is known from DE 32 04 927 C1, in which the shaved pencil lead material on the one hand and the shaved casing material on the other hand are collected in different shavings collection chambers. For this purpose, a shavings collection chamber is situated in each case above and below the plane formed by the cutting blade and the areas adjoining it. The shavings collection chamber above the cutting blade is used for collecting the pencil lead casing material, and the shavings collection chamber below the cutting blade is used for storing the shaved pencil lead material. Both collection chambers are connected to one another by slots designed in the manner of a sieve. During sharpening, the shaved pencil lead material forms a long shaving in the manner of a helical shaving, which passes into the shavings collection chamber situated above the cutting blade. This ensures that only casing material is actually collected in the shavings collection chamber situated above the cutting blade. The much lighter and finer, granular shaved pencil lead material either falls directly into the shavings collection chamber situated below the cutting blade, or passes, initially together with the casing material, into the shavings collection chamber situated above the cutting blade, and is then sieved, in a manner of speaking, into the lower shavings collection chamber. It cannot be ruled out that residues of the pencil lead material may still remain in the shavings collection chamber provided for the casing material, so that in the final analysis, the casing material does not remain sorted by type.

A pencil sharpener having a container that is open at the top is known from JP H02-144 499 U. According to the figures of the drawing, the cutting blade for the pencil sharpener in question is shaped in a special way in order to produce a convex pencil tip during sharpening. Lastly, a sharpener is known from DE 10 2010 031 915 A1 which has a peeling blade for producing a pencil tip, and a contouring tool for introducing a shoulder between the pencil tip and the pencil casing. A collection container for shaved material is not addressed in this publication.

In light of the above discussion, the object of the invention is to design a pencil sharpener in such a way that the shavings of pencil lead material on the one hand and of casing material on the other hand that result during shaving of the pencil tip are disposed of in each case sorted by type.

This object is achieved according to the invention by the feature combination of Claim 1. The back-referenced claims contain refinements of the present invention that are in part advantageous, and in part inventive on their own.

The invention is based on the fundamental concept of situating a guide element in the area of the main cutting edge of the cutting blade. This guide element acts precisely in the area of the separating line in the transition area between the pencil lead section and the casing section at the pencil tip. The guide element, similar to a traffic island for flowing traffic, acts to separate the shavings discharge flow of the pencil lead material on the one hand and of the pencil lead casing material on the other hand. As a result of this design, the material separation between the pencil lead material and the casing material takes place exactly at the point of action, i.e., at the location where the shavings actually arise. This effectively prevents the shaved materials, i.e., the shavings that arise, from unintentionally mixing. Instead, separate discharge of the shavings, i.e., from the pencil lead material on the one hand and from the pencil lead casing material on the other hand, is effectively ensured.

This strictly separate disposal of pencil lead material and pencil lead casing material is advantageous, for example, in cases in which either the pencil lead material or the pencil lead casing material is to be used or recycled. Sorting purity is often a fundamental prerequisite in such recycling processes.

Lastly, in the artistic or cosmetic fields it is also conceivable, for example, to recycle the pencil lead material separately from the pencil, since due to the application of the pencil lead material without a pencil, for example using a brush or a similar tool, specialized effects desired by the user may be achieved which require sorting purity of the shavings.

In one advantageous embodiment, the guide element is longitudinally displaceable along the main cutting edge of the cutting blade. In this way, pencil tips having pencil lead sections of different lengths may be implemented while strictly maintaining the separation of shavings, namely, the separation of shavings from pencil lead material and shavings from pencil lead casing material. The flexibility of use of the pencil sharpener or its field of application may be greatly increased in this way. Additionally or alternatively, the guide element may be designed to be rotatable with respect to the main cutting edge of the cutting blade.

In another embodiment variant, it is provided to adapt the guide element either to the top side or to the bottom side of the cutting blade. In one alternative embodiment, the guide element is adapted to the cutting blade on both sides. In one special embodiment, the guide element may also wrap around the cutting blade on both sides.

Another preferred embodiment involves the design of the guide element as a guide rib that bridges the shavings discharge joint.

In another preferred embodiment, the guide element is fixed to the body edge opposite from the main cutting edge and the adjoining area of the body. In one advantageous design, the guide element in turn bridges, at least partially, the shavings discharge joint formed between the main cutting edge and the body edge. Also in this embodiment, the guide element may be designed to be longitudinally displaceable with respect to the main cutting edge of the cutting blade and/or rotatable with respect to the main cutting edge of the cutting blade.

In another embodiment of the invention, it may also be provided to distribute multiple guide elements over the circumference of the pencil tip.

Lastly, in another embodiment it is proposed to integrally mold the guide element in one piece onto the sharpener body. In addition, the guide protrusion may be designed as a shavings guiding edge that is integrally molded in one piece onto the main cutting edge and also onto the body edge.

In general, a very large number of different variants of the fixing of the guide element to the pencil sharpener are conceivable. In addition to the above-mentioned one-piece integral molding of the guide element onto the sharpener body, detachably fixing the guide element to the sharpener body is also possible. Thus, the guide element may be fixed to the sharpener body or also to the cutting blade by means of a plug-in connection. It is also possible to screw the guide element to the pencil sharpener. The fastening screw for the cutting blade on the sharpener body, which is usually present anyway, is particularly advantageously suited for this purpose. Furthermore, it is also possible to adapt the guide element to a container of a container sharpener. In addition, further accessories such as cleaning rods or other mounting parts, described as a carrier plate in EP 1 070 601 A1, for example, are conceivable and suitable for fixing the guide element.

In another advantageous embodiment, the guide element is designed as a guide protrusion. It is advantageous to situate this guide protrusion in the area of the shavings discharge joint, which is usually formed between the main cutting edge of the cutting blade on the one hand, and the body edge of the sharpener body oppositely situated in the cone transverse direction on the other hand. The guide protrusion may be designed as a wedge-shaped separating wedge.

This design may be combined very well with a two-part shavings collection container. This shavings collection container has two separate shavings collection chambers, one for the shaved pencil lead material and one for the shaved casing material. The shavings collection chambers adjoin one another along a shared joint. A guide protrusion is advantageously provided at the edge of one or both shavings collection chambers in the area of the joint, and protrudes into the shavings discharge joint that is formed between the main cutting edge of the cutting blade and the body edge of the sharpener body oppositely situated in the cone transverse direction when the shavings collection container is closed.

The invention is explained in greater detail with reference to the exemplary embodiment illustrated in the figures, which show the following:

FIG. 1 shows a top view of one exemplary embodiment of the pencil sharpener according to the present invention,

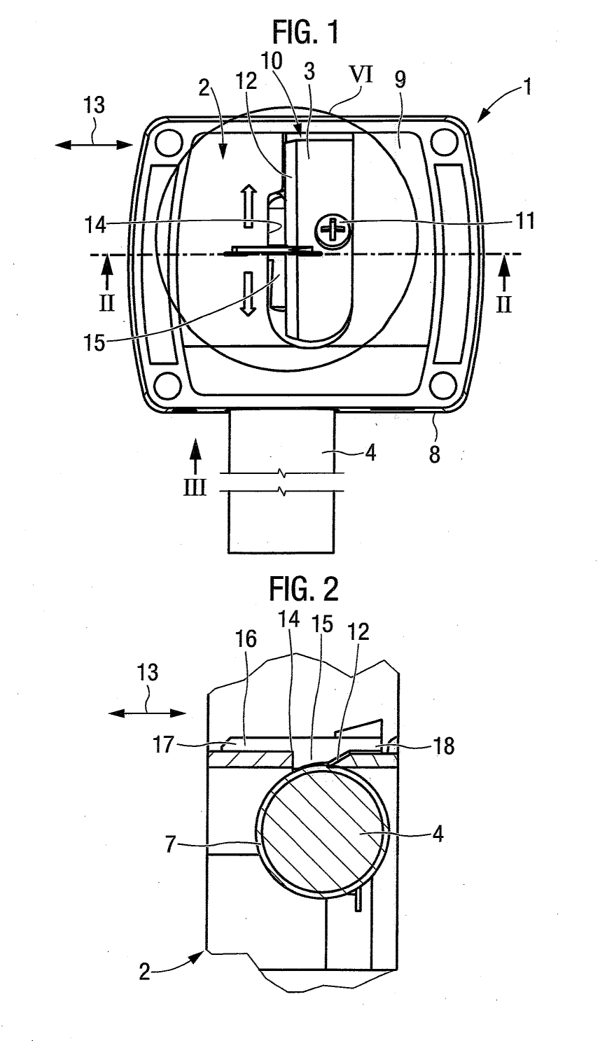

FIG. 2 shows the area of the pencil sharpener with the guide element according to section II-II in FIG. 1, as a detailed illustration,

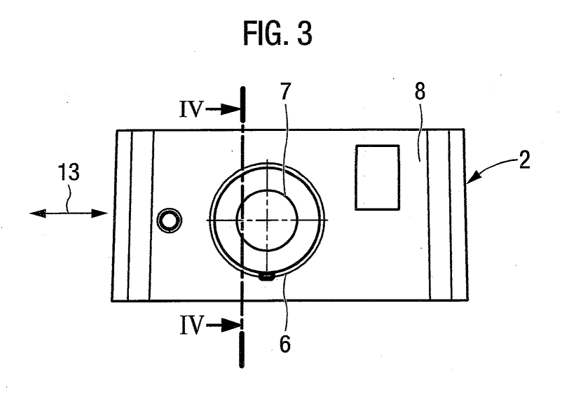

FIG. 3 shows the side view from the viewing direction according to the directional arrow III in FIG. 1,

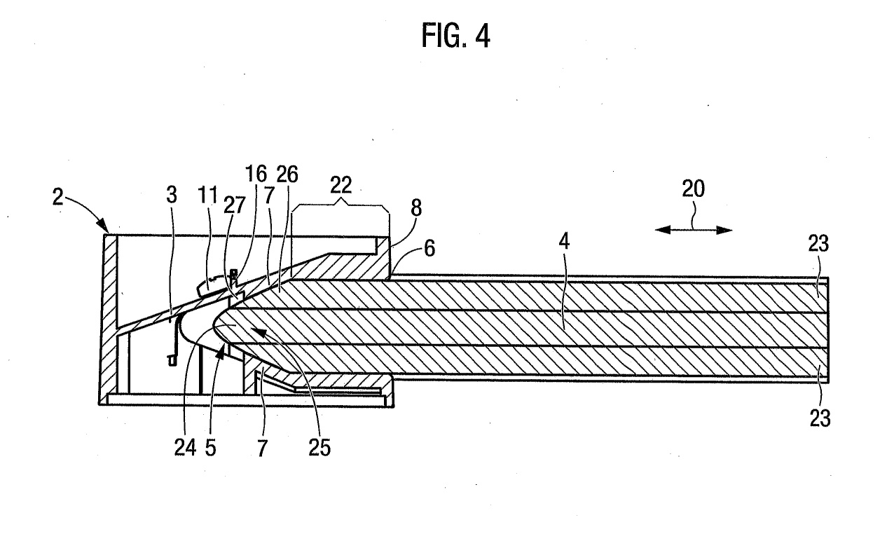

FIG. 4 shows section IV-IV from FIG. 3,

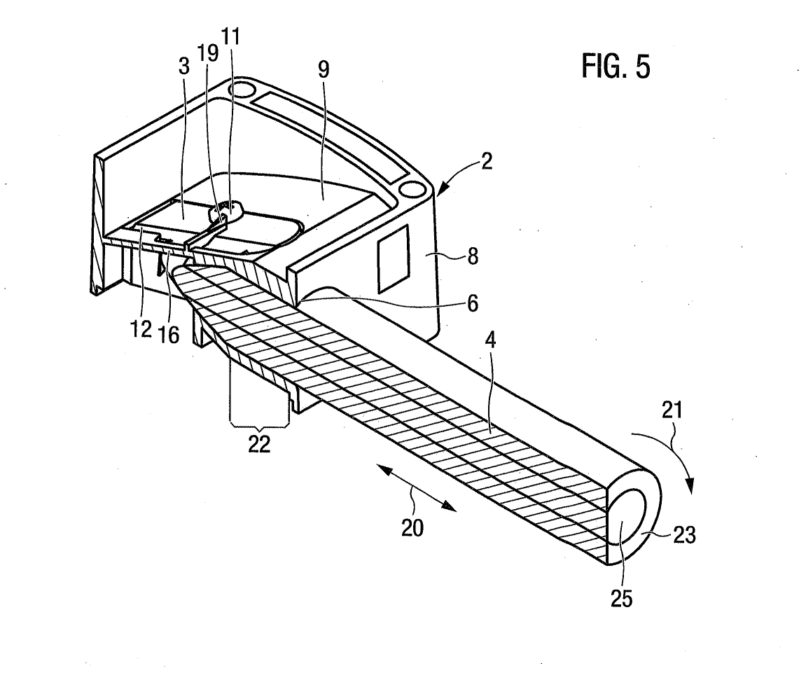

FIG. 5 shows a perspective view of the section shown in FIG. 4,

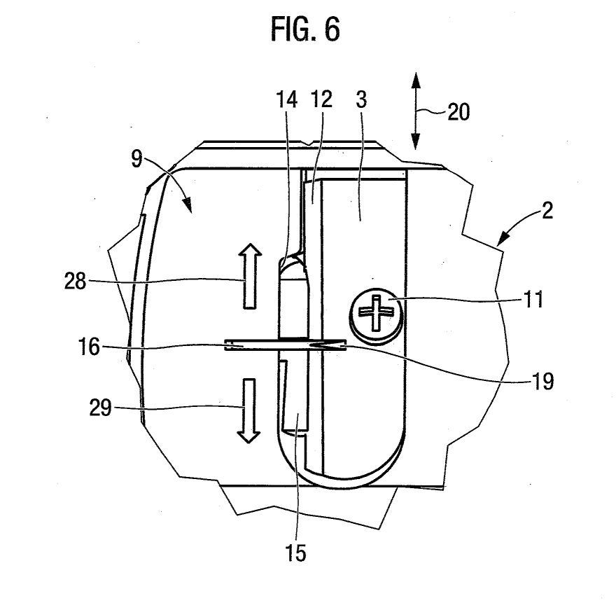

FIG. 6 shows detail VI from FIG. 1,

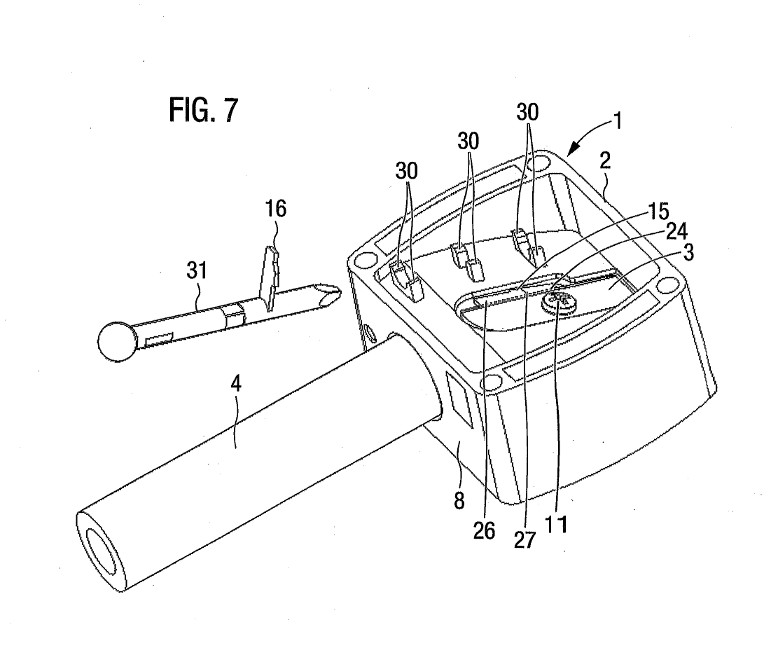

FIG. 7 shows a perspective illustration of one embodiment of the pencil sharpener, with a cleaning rod that is adaptable to the pencil sharpener and with a guide element that is fixed to the cleaning rod, prior to installation,

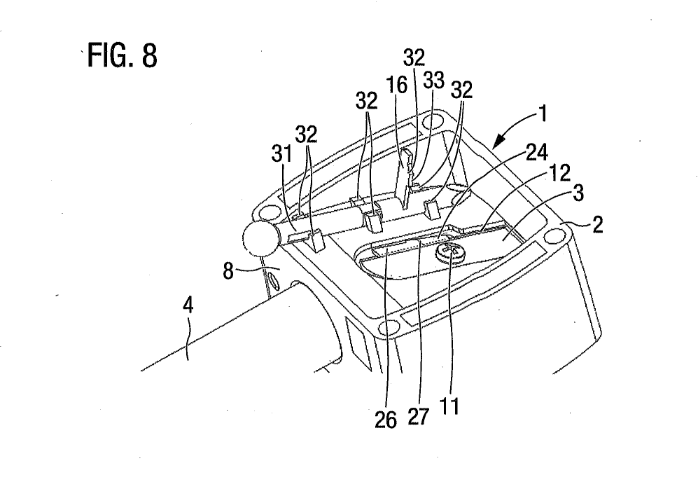

FIG. 8 shows the pencil sharpener according to FIG. 7 with the cleaning rod, fixed to the sharpener body, in an intermediate installation position,

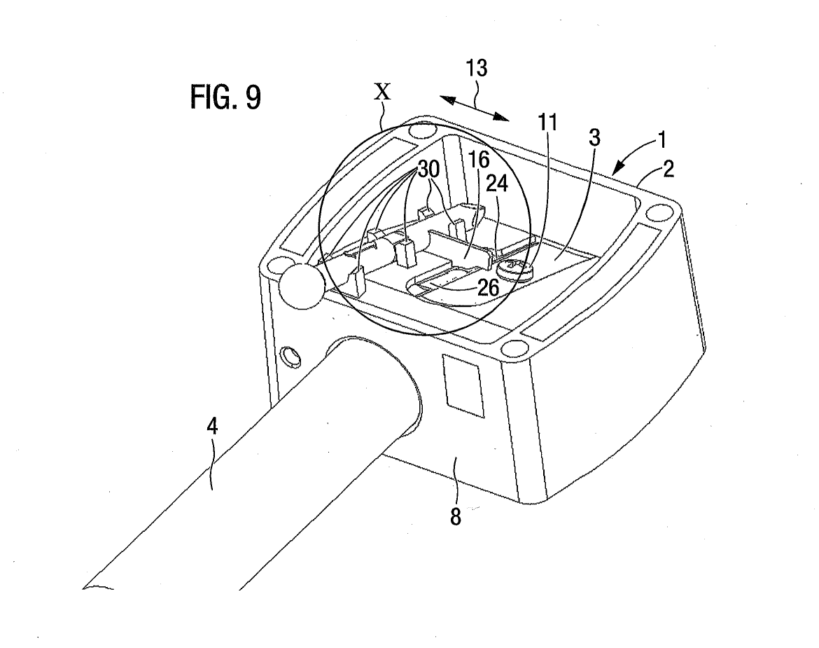

FIG. 9 shows the pencil sharpener from FIG. 8 in its final installation position,

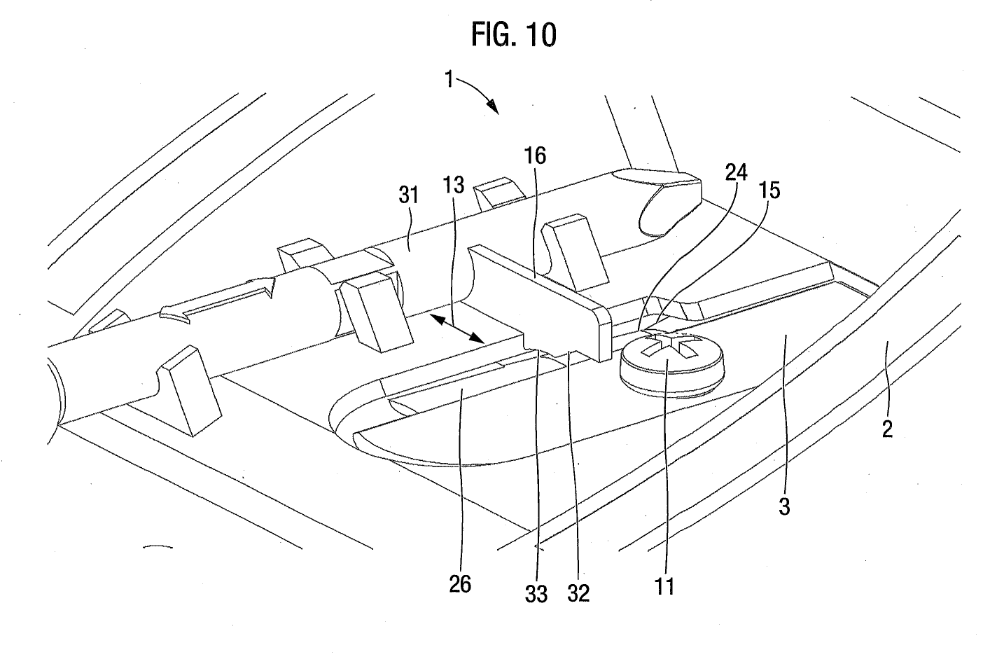

FIG. 10 shows detail X from FIG. 9,

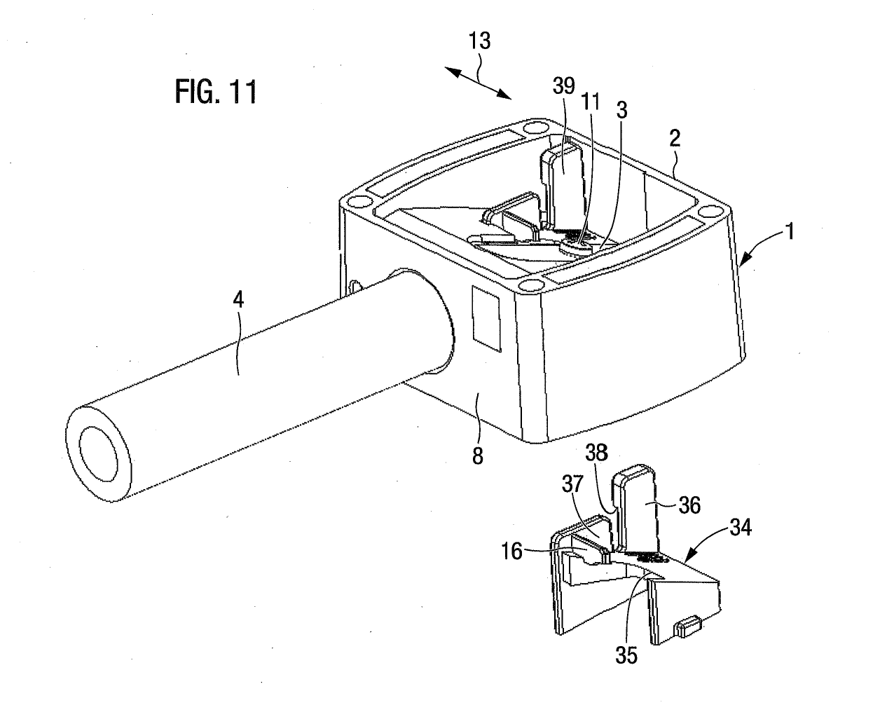

FIG. 11 shows an exploded illustration of a pencil sharpener with a shaping tool, which is insertable into the sharpener body, for shaping the pencil lead tip and with a guide element that is integrally molded onto the shaping tool,

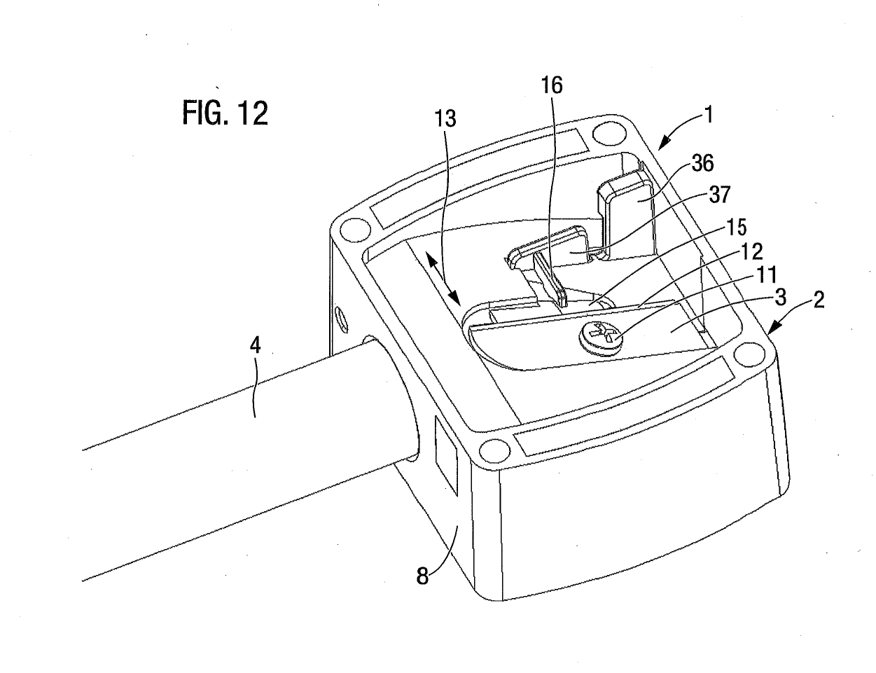

FIG. 12 shows the pencil sharpener from FIG. 11 with the shaping tool inserted,

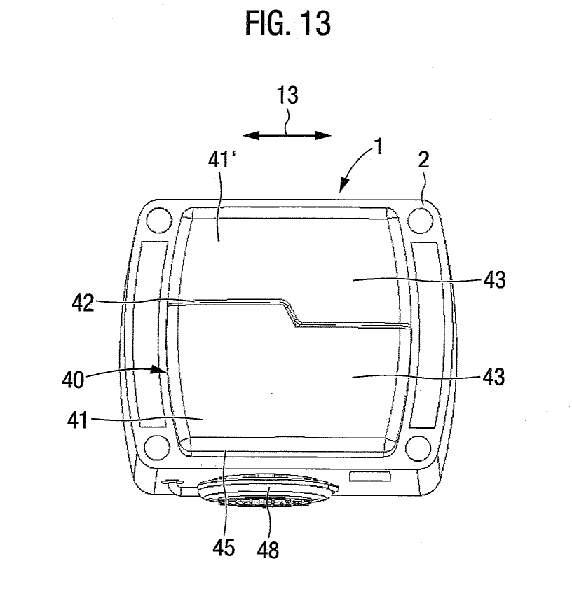

FIG. 13 shows a perspective illustration of a pencil sharpener with a two-part shavings collection container in the closed position,

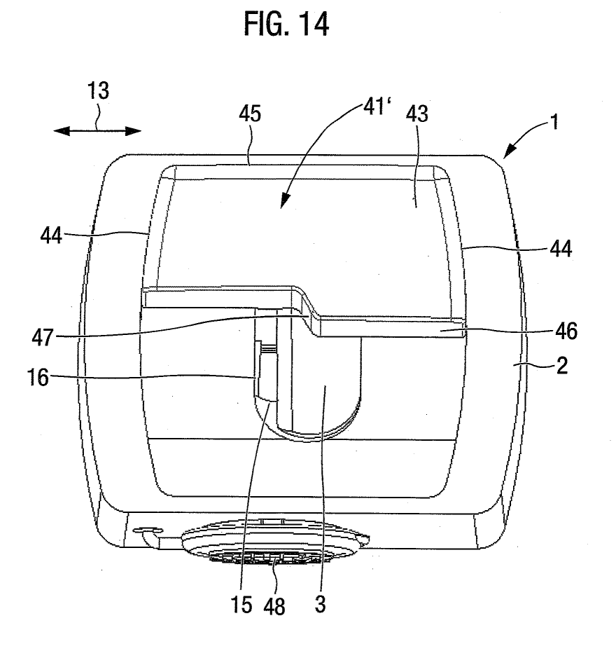

FIG. 14 shows the pencil sharpener from FIG. 13 with the shavings collection container partially opened, and

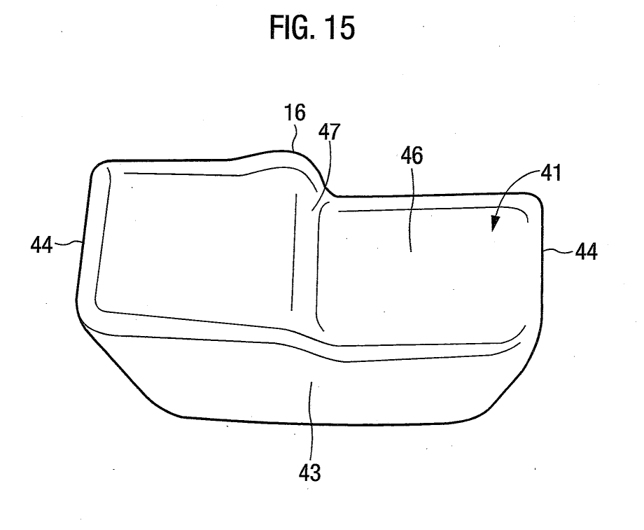

FIG. 15 shows a side view of the side wall, which forms the joint, of a shavings collection container.

The pencil sharpener 1 is made up essentially of a sharpener body 2 and a cutting blade 3, which in the exemplary embodiment is screwed to the top side of the sharpener body 2. The pencil 4 to be sharpened is schematically indicated in the illustration in FIG. 1. The end of the pencil 4 having the pencil tip 5 that results from the sharpening operation is inserted through a cone insertion opening 6 into a guide cone 7 situated in the sharpener body 2. For this purpose, the cone insertion opening 6 passes through a body side wall 8. The body side wall 8 extends perpendicularly with respect to the body cover area 9 shown in FIG. 1. A blade seat 10 for the cutting blade 3 is molded into the body cover area 9. The cutting blade 3 is fixed in the blade seat 10 by means of a fastening screw 11.

The cutting blade 3 has a main cutting edge 12. The main cutting edge 12 forms the actual sharpener blade for shaving the pencil tip 5 during sharpening of the pencil 4. The main cutting edge 12 extends tangentially with respect to the sharpener cone 2. The body edge 14 is situated opposite from the main cutting edge 12 in the cone transverse direction 13. The main cutting edge 12 and the body edge 14 are spaced apart from one another in the cone transverse direction 13 in such a way that they mutually delimit a shavings discharge joint 15. During sharpening of the pencil tip 5, the cut shavings are discharged outwardly through this shavings discharge joint 15, over the main cutting edge 12 which acts as the sharpener blade, and the top side, relative to the sharpener body 2, of the cutting blade 3 visible in FIG. 1.

The guide element 16, designed as a guide rib in the exemplary embodiment, is particularly apparent in the illustration in FIG. 2. The guide element 16 with its stationary end 17 is fixed in the area of the body edge 14 and the area of the body cover area 9 adjoining the body edge 14, at the left in the exemplary embodiment in FIGS. 1 and 2. As is clearly apparent in FIG. 2, the guide element 16 bridges the shavings discharge joint 15 in the cone transverse direction 13, and in the cone transverse direction 13 protrudes beyond the main cutting edge 12 and the adjoining cover area of the cutting blade 3. The guide element 16 bears a further guide fin 19 on its free end 18 that protrudes beyond the cover area of the cutting blade 3 in the cone transverse direction 13.

FIG. 4 shows the pencil 4 which extends in its center longitudinal direction 20, and whose left end in FIG. 4 passes through the body side wall 8 into the cone insertion opening 6, and which is shaved by a rotary movement in the rotational direction 21 with respect to the pencil tip 5. The guide channel 22 of the pencil sharpener 1, which extends between the guide cone 7 and the cone insertion opening 6, is also apparent in FIG. 4. The guide channel 22 is used as a sliding guide for the pencil 4 in the area of its outer casing that is remote from the pencil tip 5 and that is not sharpened or shaved.

The pencil 4 is initially made up of its pencil lead casing 23 and the pencil lead 25 embedded in the pencil lead casing 23. The pencil lead casing 23 is made of casing material, and the pencil lead 25 is correspondingly made of pencil lead material.

The main cutting edge 12 of the cutting blade 3 shaves the pencil tip 5 in such a way that a free pencil lead section 24 emerges from the pencil lead casing 23 and the pencil lead casing material. The conically tapered casing section 26 extends in the center longitudinal direction 20 next to the pencil lead section 24, to the right in FIG. 4. A separating line 27 is formed in the transition area from the pencil lead section 24 to the casing section 26, viewed in the center longitudinal direction 20 of the pencil 4. The guide element 16 engages with the pencil tip 5 in the area of this separating line 27. In this way, the guide element 16 separates the shavings that are shaved from the pencil lead tip in the pencil lead section 24 from the shavings that are shaved from the casing section 26. The shavings from the pencil lead section 24 as well as the separate shavings from the casing section 26 are discharged through the shavings discharge joint 15 and out of the sharpener body 2.

It is apparent from the illustration in FIG. 6 that the shavings from the pencil lead section 24 are discharged from the sharpener body 2 in the shavings discharge direction 28, while the shavings that are shaved from the casing section 26 exit from the sharpener body 2 in the opposite casing discharge direction 29, viewed in the center longitudinal direction 20. For the sake of clarity, it is noted that the center longitudinal direction 20 of the pencil 4 corresponds to the center longitudinal direction 20 of the sharpener body 2 when the pencil 4 rests in the sharpener body 2 or in the guide cone 7 and the guide channel 22, as shown in FIGS. 4 and 5.

In the illustration in FIG. 7, once again a pencil 4 is introduced into the guide cone 7 in the sharpener body 2 of the pencil sharpener 1. Hook-shaped receiving arms 30 are mounted on the sharpener housing 2. These receiving arms 30 form a detent bearing for a cleaning rod 31. The cleaning rod 31 together with the receiving arms 30 forms a snap-on connection, and may thus be snapped onto the sharpener body 2 of the pencil sharpener 1. The guide cone 7 and the shavings discharge joint 15 may be cleaned with the cleaning rod 31. The guide element 16 is integrally molded onto the cleaning rod 31. The guide element 16 protrudes transversely with respect to the center longitudinal axis of the cleaning rod 31 in the cone transverse direction 13. The guide element 16 bears an extension 32 with a concave recess 33 on its border edge facing the shavings discharge joint 15 in the final installed state (FIGS. 9 and 10). The extension 32 protrudes with its concave recess 33 into the shavings discharge joint 15 in such a way that the recess 33 is tangential to the pencil in the area of the separating line 27 between the pencil lead section 24 and the casing section 25. The installation of the cleaning rod 31 used as a support for the guide element 16 is apparent from the illustration in FIG. 8. The cleaning rod 31 is pushed between the oppositely situated pairs of receiving arms 30 until the cleaning rod 31 assumes the intermediate position illustrated in FIG. 8. The receiving arms 30 and the outer casing of the essentially cylindrical cleaning rod 31 form a hinge bearing. The cleaning rod 31 is then turned to the right from the position illustrated in FIG. 8 until the guide element 16 reaches the final installation position illustrated in FIGS. 9 and 10, namely, with its extension 32 engaging in the shavings discharge joint 15.

The shaping tool 34 illustrated in FIG. 11 is made up of a shaping template 35, which in the exemplary embodiment is rounded, for shaping the tip of the pencil lead 25 of the pencil 4. A grip tab 36 for installing and removing the shaping tool 34 on/from the sharpener 1 or its sharpener body 2 is also provided on the shaping tool 34. In addition, a support plate 37 is integrally molded onto the grip tab 36, at the left in the exemplary embodiment in FIG. 11. The guide element 16 protrudes transversely from the support plate 37. The guide element 16 is thus supported by the support plate 37. Based on the exemplary embodiment in FIG. 11, the shaping tool 34 may be easily inserted into the sharpener body 2 from the bottom. A hook-like protrusion 38 is formed on the grip tab 36 for fixing the shaping tool 34 in the sharpener body 2. In the final installed state illustrated in FIG. 12, this hook-like protrusion 38 engages behind the top edge of a fastening rib 39 formed in the pencil [sic; sharpener] body 2. The shaping tool 34 and the sharpener body 2 thus also form a snap-on connection for fixing the shaping tool 34 in the sharpener 1.

In the final installed state, the guide element 16 protrudes from the support plate 37 in the cone transverse direction 13 and into the shavings discharge joint 15 adjoining the cutting edge of the cutting blade 3. The design of the guide element 16 on the shaping tool 34 corresponds to the design of the guide element 16 on the cleaning rod 31. The guide element used in the exemplary embodiment in FIGS. 11 and 12 thus also has an extension 32 with a concave recess 33, which in the final installed state (FIG. 12) protrudes into the shavings discharge joint 15.

FIG. 13 shows another embodiment of the pencil sharpener 1, together with its sharpener body 2 and a shavings collection container 40 mounted on the top side of the sharpener body 2. The shavings collection container 40 is made up of two partial containers 41, 41′, which in the exemplary embodiment are identical. The partial containers 41, 41′ are mounted on the sharpener body 2 in a mirror-inverted arrangement relative to one another, forming a joint 42 between them.

The partial containers 41, 41′ have essentially a hollow cuboidal design. To this end, the partial containers each have a cover area 43, two narrow side walls 44, an outer side wall 45, and an inner side wall 46. The base of the partial containers 41, 41′ facing away from the cover area 43 is open. With their open bases, the partial containers 41, 41′ are placed over the top side of the sharpener body 2 and over the shavings discharge joint 15 and the cutting blade 3 adjoining it. The shavings that arise during sharpening fall through the shavings discharge joint 15 into the respective partial container 41, 41′.

The partial containers 41, 41′ rest with their inner side walls 46 against one another in the closed position of the pencil sharpener 1. The joint 42 extending in the cone transverse direction 13 is thus formed between the inner side walls 46. The joint 42, in a manner of speaking, bridges the cutting blade 3 and the shavings discharge joint 15 in the cone transverse direction 13. The inner side walls 46 each have an offset 47 approximately in their center. A guide element 16 designed as a guide protrusion is integrally molded onto the edge of the inner side wall 46 in the area of the offset 47. This guide element 15 [sic; 16] designed as a guide protrusion protrudes from the top into the shavings discharge joint 15 when the shavings collection container 40 or the partial containers 41, 41′ is/are mounted. However, it is sufficient for a guide element 16 to be integrally molded onto only one of the partial containers 41, 41′.

Lastly, a further shavings collection container 40 may also be situated on the bottom side of the sharpener 1, not visible in FIGS. 13 and 14. In addition, a cap 48 that closes the guide cone 7 is visible in FIGS. 13 and 14.

It is thus possible with the invention for the shavings that arise during sharpening to be disposed of in opposite discharge directions, namely, the shavings discharge direction 28 and the casing discharge direction 29, thus ensuring complete separation of the shavings. In the embodiment according to FIGS. 13 through 16, the separated shavings are disposed of in the partial container 41 on the one hand, and in the partial container 41′ on the other hand.

### LIST OF REFERENCE NUMERALS

1 pencil sharpener
2 sharpener body
3 cutting blade
4 pencil
5 pencil tip
6 cone insertion opening
7 guide cone
8 body side wall
9 body cover area
10 blade seat
11 fastening screw
12 main cutting edge
13 cone transverse direction
14 body edge
15 shavings discharge joint
16 guide element
17 stationary end
18 free end
19 guide fin
20 center longitudinal direction
21 rotational direction
22 guide channel
23 pencil lead casing
24 pencil lead section
25 pencil lead
26 casing section
27 separating line
28 shavings discharge direction
29 casing discharge direction
30 receiving arm
31 cleaning rod
32 extension
33 concave recess
34 shaping tool
35 shaping template
36 grip tab
37 support plate
38 protrusion
39 fastening rib
40 shavings collection container
41, 41′ partial container
42 joint
43 cover area
44 narrow side wall
45 outer side wall
46 inner side wall
47 offset
48 cap

1. A pencil sharpener comprising:
a sharpener body;
at least one guide cone situated in the sharpener body for guiding a pencil tip during sharpening;
a cutting blade fixed to the sharpener body, tangentially with respect to the at least one guide cone, for shaving the pencil tip in such a way that the pencil tip at a front end has a tapered pencil lead section without casing material, and an adjoining casing section in a center longitudinal direction of the pencil with a pencil lead casing made of casing material in which the pencil lead of the pencil is embedded; and
a guide element, which is situated in an area of a main cutting edge of a cutting blade and which engages with the pencil tip in the area of the separating line in the transition area between the pencil lead section and the casing section, acts on the pencil tip, without cutting, in such a way that shavings of the pencil lead material in the pencil lead section and shavings of the casing material in the casing section are discharged separately.

2. The pencil sharpener of claim 1, wherein the guide element is supported on the cutting blade and is longitudinally displaceable in the longitudinal direction of the main cutting edge of the cutting blade and/or rotatable.

3. The pencil sharpener of claim 1, wherein a guide rib is the guide element and bridges a shavings discharge joint.

4. The pencil sharpener of claim 1, wherein the guide element is fixed to a body edge opposite from the main cutting edge and an adjoining area of the sharpener body, and the guide element protrudes in the direction of the main cutting edge in such a way that the guide element at least partially bridges a shavings discharge joint formed between the main cutting edge and a body edge.

5. The pencil sharpener of claim 4, wherein the guide element is detachably fixed to the sharpener body.

6. The pencil sharpener of claim 1, wherein the guide element is fixed to a functional part that is detachably fixed to the sharpener body.

7. The pencil sharpener of claim 6, further comprising a cleaning rod as a functional part.

8. The pencil sharpener of claim 6, further comprising a shaping tool as a functional part.

9. The pencil sharpener of claim 1, wherein a guide protrusion, as a guide element, situated in an area of a shavings discharge joint between the main cutting edge of the cutting blade and the body edge of the sharpener body oppositely situated in a cone transverse direction.

10. The pencil sharpener of claim 9, wherein the guide protrusion is situated at a joint of a shavings collection container that is divided into two parts by the joint.
